(19) United States
(12) Patent Application Publication
(10) Pub. No.: US 2014/0330496 A1
(43) Pub. Date: Nov. 6, 2014

(54) TRAINABLE ROBOTIC APPARATUS, SYSTEM AND METHOD

(71) Applicants: Austin Crouse, Landenberg, PA (US); Michael Balles, Severn, PA (US)

(72) Inventors: Austin Crouse, Landenberg, PA (US); Michael Balles, Severn, PA (US)

(21) Appl. No.: 14/193,929

(22) Filed: Feb. 28, 2014

Related U.S. Application Data
(60) Provisional application No. 61/816,563, filed on Apr. 26, 2013.
(60) Provisional application No. 61/770,836, filed on Feb. 28, 2013.

(51) Int. Cl. A01D 34/00

(52) U.S. Cl. CPC A01D 34/008
USPC 701/70

(57) ABSTRACT

An automated, robotic apparatus, system and method, such as a robotic lawnmower apparatus, system and method, and a control system for same. The present invention provides an automated, robotic apparatus, system and method for mowing lawns, and similar outdoor applications, in both residential and commercial applications, such as in order to provide preferred cut grass patterns across one or several different lawns with a single robotic unit.

### RELATED APPLICATIONS

This application claims the benefit of U.S. Provisional Application Ser. No. 61/770,836, filed Feb. 28, 2013, for a “Trainable Robotic Apparatus, System and Method”, and U.S. Provisional Application Ser. No. 61/816,563, filed Apr. 26, 2013, for a “Trainable Robotic Apparatus, System and Method” both of which are incorporated herein by reference in their entireties.

### BACKGROUND OF THE DISCLOSURE

1. Field of the Disclosure

The disclosure relates to robotics, and, more particularly, relates to a trainable robotic apparatus, system and method, such as a trainable robotic lawnmower.

2. Description of the Background

Lawnmower technology has been available for a great many years. Additionally, robotics technology has likewise been available for quite some time. However, automated, robotic solutions for certain commercial, and more particularly, residential, applications, such as mowing lawns, has not yet been provided.

Robotic solutions have been provided for some limited applications in residential settings. For example, robotic vacuum cleaners are well known in the art. However, such robotic vacuum cleaners do not provide an acceptable solution in other applications, such as in a lawn mowing environment, at least because the sensing employed in a vacuuming embodiment does not necessitate an attractive pattern on carpet as would be expected on a mowed lawn. Further, residential robotic embodiments typically are not sufficiently robust in nature to allow for repeated outdoor use over lengthy periods of time.

Robotic solutions have likewise been provided in some limited commercial and industrial settings. For example, U.S. Pat. No. 8,260,483 is illustrative of an underground mining vehicle that provides automated mining operations. Further, robotic units are well established in, for example, hospital environments, such as in order to provide automated delivery of medication or equipment for use by hospital personnel. However, it is typical in such embodiments that no outdoor applications remotely akin to mowing a lawn are provided, and further it is the case in such embodiments that the robotic route is not particularly complex, i.e., most robotic paths taken in such embodiments are straight line paths with little possibility of interference other than passing humans or equipment. Further, it is typical in such commercial or industrial embodiments that the robotic path is “marked” by, for example, RF ID markers or similar technologies placed along the path, such that the robotic unit simply moves from one marker to the next. However, it almost goes without saying that it would be exceedingly difficult to “mark” a lawn or similar outdoor embodiment in a similar manner, due at least to the much broader space and alternative possible paths, as the aforementioned commercial or industrial applications of robotics.

Therefore, the need exists for an automated, robotic apparatus, system and method for mowing lawns, and similar outdoor applications, in both residential and commercial applications, such as in order to provide preferred cut grass patterns across one or several different lawns with a single robotic unit.

### SUMMARY OF THE INVENTION

The present invention includes and is directed to an automated, robotic apparatus, system and method, such as a robotic lawnmower apparatus, system and method, as well as to and including a control system for same. Accordingly, the present invention provides an automated, robotic apparatus, system and method for mowing lawns, and similar outdoor applications, in both residential and commercial applications, such as in order to provide preferred cut grass patterns across one or several different lawns with a single robotic unit.

### BRIEF DESCRIPTION OF THE FIGURES

The disclosure will be described in conjunction with the following figures, in which like numerals represent like elements, and in which:

FIGS. 1A-1F are schematic illustrations of aspects of the present invention;

FIG. 2 is a schematic block diagram of aspects of the present invention; and

FIG. 3 is a flow diagram illustrating aspects of the present invention.

FIG. 4 is a flow diagram illustrating aspects of the present invention.

FIG. 5 is a block diagram illustrating aspects of the present invention.

### DETAILED DESCRIPTION

The figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical robotic devices, systems, and methods. Those of ordinary skill may recognize that other elements and/or steps may be desirable or necessary to implement the devices, systems, and methods described herein. Because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art.

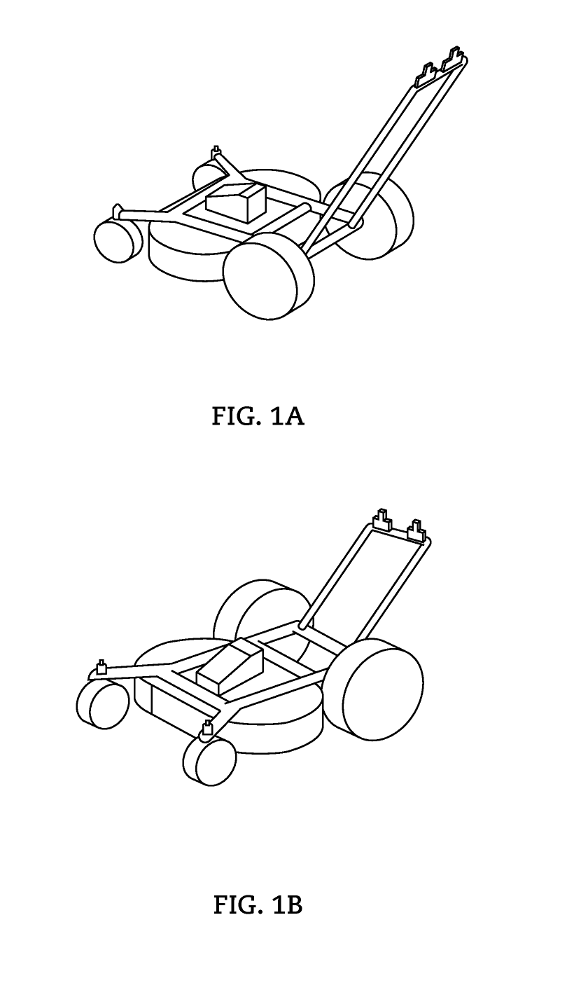

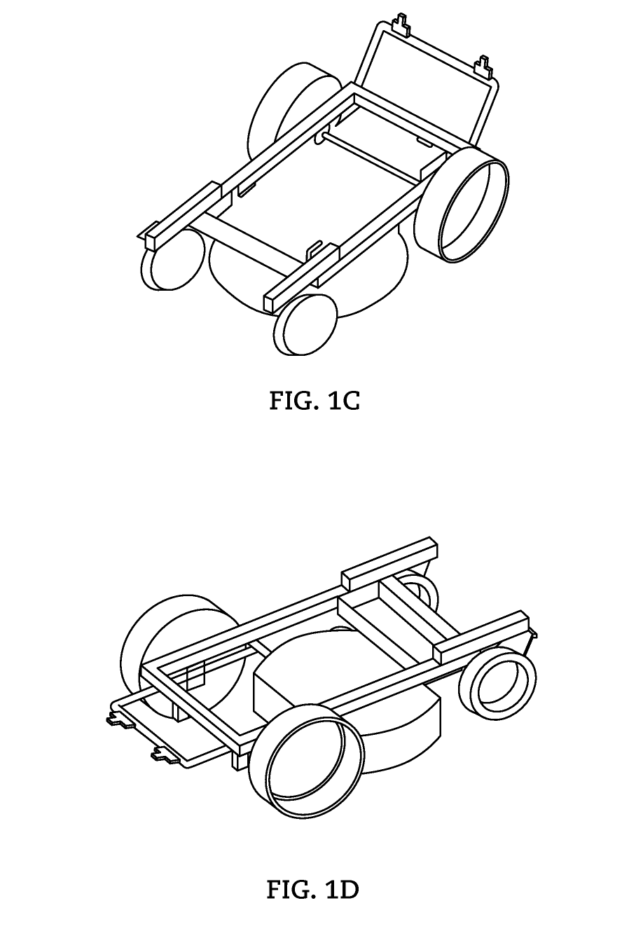

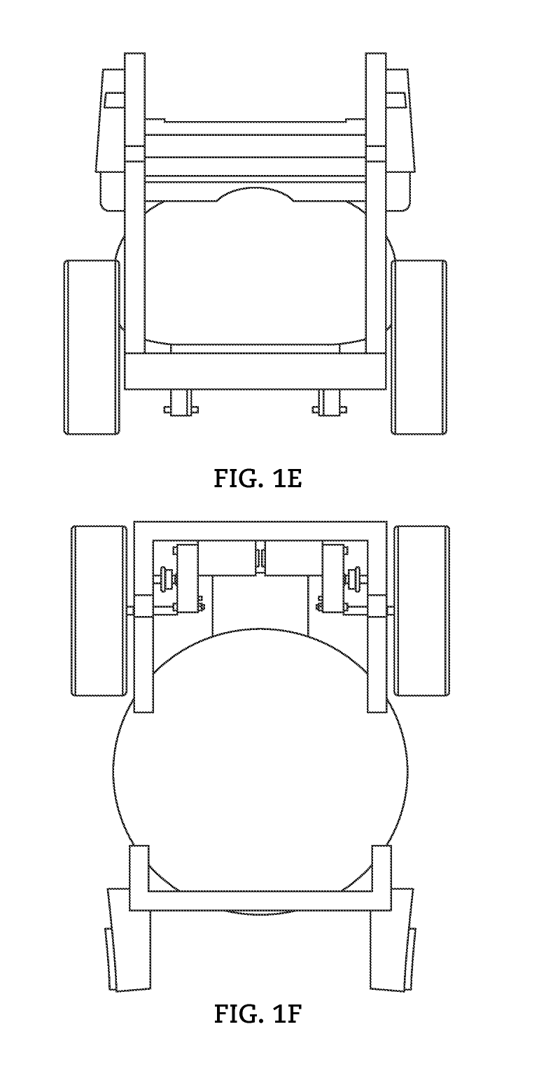

The present invention includes and is directed to an automated, robotic apparatus, system and method, such as a robotic lawnmower apparatus, system and method, as well as to and including a control system for same. As such, FIGS. 1A-1F illustrate an exemplary embodiment of lawnmower hardware in accordance with the present invention. In the illustrative exemplary embodiment shown, the lawnmower includes a frame and four wheels, although those skilled in the art will appreciate that three wheels or more than four wheels may be used. In a particularly preferred embodiment, at least two of the wheels include encoders, as shown, which encoders are comprised of any suitable device for tracking rotation of a drive or non-drive wheel. Further shown are at least one microcontroller, which is defined herein to include any microprocessor device, and at least one memory module. The memory module may be, for example, a RAM, ROM, PROM, flash drive, hard drive, or any other memory device known to those skilled in the art.

Also illustrated in FIG. 1 is at least one motor to drive each drive wheel physically associated with the frame, and, in an exemplary lawnmowing embodiment, at least one motor to drive rotation of at least one cutting blade. As such, information may be stored in the memory module and accessed and executed by the microcontroller in order to drive the drive motor by causing the drive wheels to execute data commands and thereby move the lawnmower frame. Further, those skilled in the art will appreciate that the second motor spins at least one cutting blade in order to cut grass, and at a rate that allows for the cutting of grass. Moreover, the microcontroller may similarly control the timing of the blade motor spinning the blade and stopping the blade.

By way of non-limiting example, and as shown in the exemplary embodiment of FIG. 1, a lawnmower in accordance with the present invention may include additional aspects. For example, one or more gear boxes may be included in order to vary the drive gears of the drive motor. Further, for example, one or more speed controllers may be included to control and vary the speed of the drive motor driving the drive wheels. Additionally, in battery driven embodiments, a battery may be included and mounted to the frame, wherein the battery may allow for an electrically driven drive motor to spin at least the drive wheels. Those skilled in the art will appreciate that, in additional alternative embodiments, the drive wheels may be driven by a gas powered motor, or the blades may be driven by a gas powered motor, or both the blades and the drive wheels may be driven by one or more gas powered motors.

Also shown in the exemplary illustration of FIG. 1 is a joy stick that may be correspondent to each drive wheel and/or each non-drive wheel of the apparatus. Of course, a single joy stick may also be correspondent to more than one wheel of the device. The joy sticks may allow for instruction to the microcontroller to spin, for example, a drive wheel correspondent to one of the joy sticks upon actuation of that joy stick, and/or the joy stick may execute a turn in one or more wheels of the device if the wheels are mounted so as to allow, and are suitable for allowing, turning. Further included in the device may be one or more geo location modules, such as a GPS module, which may allow for geo locating of the lawnmower apparatus.

Further shown in FIG. 1 is a plurality of sensors, which sensors may be mounted to the frame, mounted to the wheels, placed on an upper handle portion that allows user control of the device and/or is associated with the joy sticks, or the like. Such sensors may preferably include, for example, ultrasonic sensors for sensing distances of the lawn mowing apparatus from items in the surroundings of the lawnmower apparatus. Further included in alternative embodiments may be one or more optical sensors, although optical sensors may be readily “fooled” by high sheen surfaces or by the shaking that occurs upon cutting of a lawn. Further included in optional embodiments may be infrared sensors, which may allow for the lawnmower apparatus to discern whether living material, such as a human or a pet, is in the intended path of the robotic device. Additional sensors may include, for example, an accelerometer, whereby changes in speed for the lawn mowing device may be sensed.

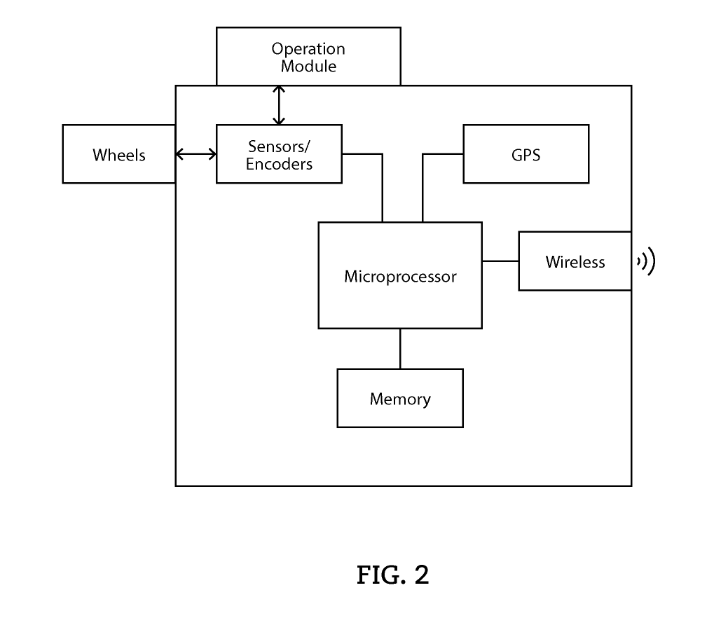

FIG. 2 is a schematic block diagram illustration of an exemplary robotic apparatus and system. FIG. 2 illustrates certain of the aspects of the lawnmower embodiment discussed with respect to FIG. 1, and further illustrates that the functionality of the device may be constituted, for example, by a function module (i.e., the cutting blades and blade motor for the lawnmower embodiment of FIG. 1).

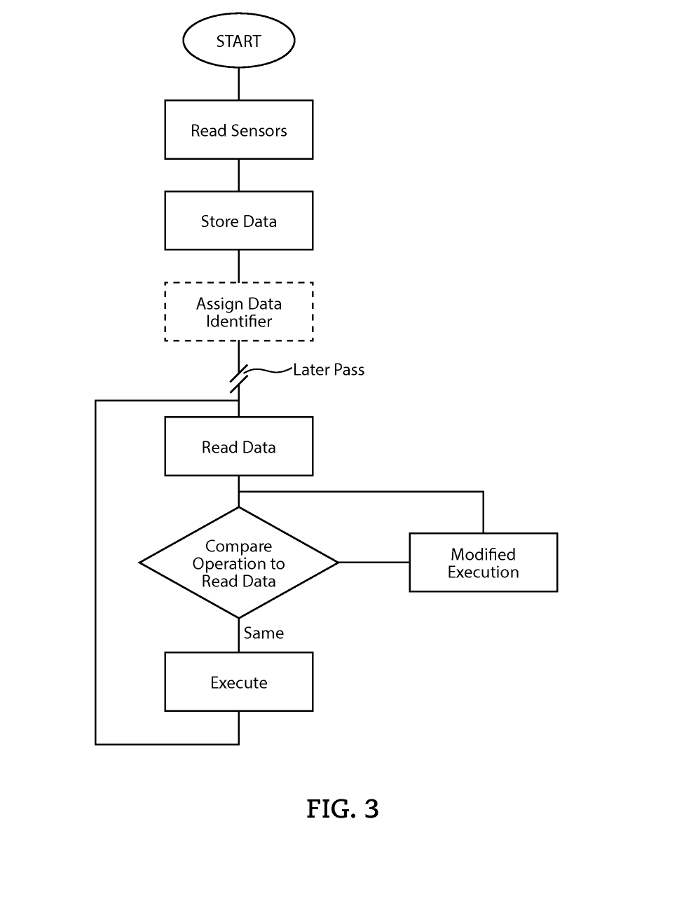

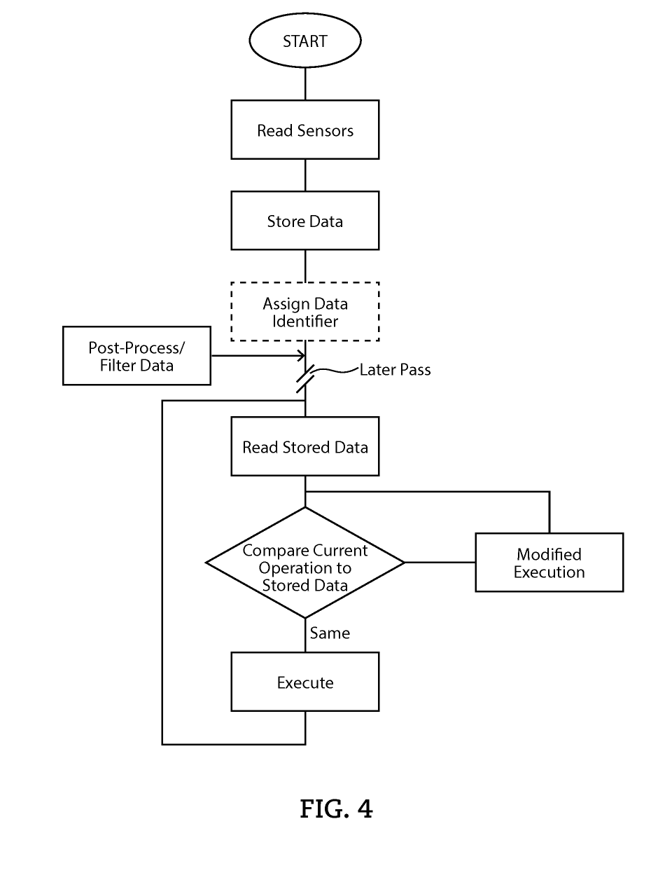

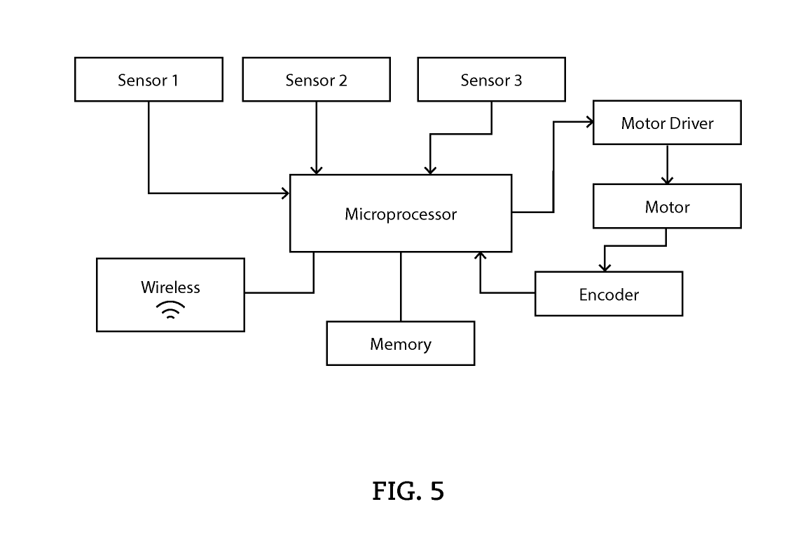

FIG. 3 is a flow diagram illustrating operation of a control system in accordance with the present invention. The control system may, for example, be executed by the microcontroller referenced in FIG. 1, and may load data to, and retrieve data from, at least the memory module referenced in FIG. 1. In brief, the control system may accumulate “first pass” data for a given lawn, and on later passes may autonomously drive the aspects of the lawnmower apparatus according to the data loaded in the first pass—i.e., the first pass may thereby “train” the robotic device for later passes. At minimum, the first pass data may include data from the wheel encoders referenced in FIG. 1. Additionally, first pass data may include data indicated by the joy sticks referenced in FIG. 1 (is so-equipped). Further, in alternative embodiments, the first pass data may include data from at least the ultrasonic sensors referenced in FIG. 1. Accordingly, the first pass data may indicate a “map” of a given lawn, including an assessment by the ultrasonic sensors of obstacles in and around the lawn, and including, via at least the wheel encoders and, in optional embodiments, the joy sticks, the manner in which a user of the lawnmower wishes later automated efforts of the lawnmower to cut the lawn.

The recorded first pass data may, as referenced, be stored in association with the memory module. Further, the microcontroller may indicate to the memory module an identifier for the data associated with each first pass map recordings stored in the memory module. That is, different first pass map recordings may have the data associated therewith stored in the memory module. For example, a GPS location, as indicated by the GPS module referenced in FIG. 1, may be stored in association with each first pass data map placed in the memory module. Thereafter, an indication by the GPS module of the location of the lawnmower may cause the microcontrollers to select the correct first pass data map for automated execution by the lawnmower on later passes. In alternative embodiments, for example, identifying information may be input in accordance with each different map, and/or a user may indicate identifying information to the microcontroller for each first pass taken. Moreover, in the case of a lawnmower unit equipped with, for example, a wired or wireless download link, one or more first pass data sets may be stored remotely from the lawnmower, and may be later accessed, automatically or manually, from the remote storage location, such as via an on-board wireless connection, for later automated passes of the lawnmower.

More particularly, the lawnmower device may make a first pass at the direction of a human operator, or via a remote indication, such as from a human operator or from a mapping program (e.g., in embodiments in which a map of a given lawn has already been drawn, such as via a survey). In accordance with this first pass, data, including wheel encoded data, may be recorded and stored in the memory module for later use during autonomous operation. Any number of data points may be stored in the memory module, as long as a sufficient number of data points are stored to enable later autonomous operation by the lawnmower unit. For example, 100, 1,000, 10,000, or more data points may be stored. In a manual operation of the first pass, a user may walk the unit along simply by pushing on a handle of the robotic lawnmower, or, in embodiments employing joy sticks, a user may operate the joy sticks while walking with the robotic unit. Upon recording at least encoder data from the first pass (which may be precise to 1/100^{th}, 1/1000^{th}, or yet more defined numbers of rotations to potentially allow for even more precise calculations), other sensor data, including at least ultrasonic sensor data, and joy stick data, if available, of each first pass data may be assigned to a data map file in memory, such as with a location stamp indicated by the GPS module. Of note, encoder data, such as when employed in conjunction with accelerometer data, may allow for automated sensing of slippage, and ultrasonic data, such as when used with or without infrared data, may allow for a sensing of new obstructions in the path of the robotic unit.

In later operations, herein termed automated or autonomous operations, the microcontroller transfers the raw data loaded to the memory on the first pass back from the memory in order to dictate the operation of at least the wheel drive motors and/or the speed controller. For example, during autonomous operation, the microcontroller may simulate joy stick movement based on previously recorded joy stick data, and may simulate wheel rotational movement based on previously recorded encoder data, and may simulate acceleration based on previously recorded accelerometer data. Further, the microcontroller will expect substantially the same readings by the sensors during autonomous operation as were sensed during the first pass. For example, if during an autonomous pass the ultrasonic sensors detect an obstacle that was not in the path of the robotic unit during the first pass, the robotic unit may pause once the obstacle is sensed within a set distance from the unit, to thereby allow the obstacle to move before the robotic lawnmower continues on its path. Further, if an accelerometer sensor senses no or little acceleration where previously acceleration was sensed, or when the drive motor is instructing the wheels to accelerate, it can be concluded that there is slippage and thus part of the first pass path needs to be recalculated and repeated by the robotic unit.

Finally, as illustrated in the flow diagram of FIG. 3, multiple autonomous operations may be stored in the onboard memory module, or at a remote memory location. Each path may be accorded an identifier, such as a GPS location indicated by the GPS module, and in such embodiments the most likely first pass path data will be retrieved from memory that is closest to the identified location, i.e., the GPS module need not indicate a precise location.

Additionally, it should be noted that, in view of the first pass path raw data accumulated on the memory module, the robotic lawnmower need not be placed at the same precise starting location for autonomous operation periods. That is, based on sensor data, the robotic lawnmower may be enabled to sense its surroundings and either pickup the first pass path at a different starting point than was indicated on the first pass, or drive the unit, such as without blade rotation, to the starting point of the first pass.

In embodiments including a gas powered motor, such as to rotate cutting blades, a battery used to run the drive wheels may be recharged through the operation of the gas motor, such as through the use of a alternator as will be understood to those skilled in the art. Further, batteries may be recharged by being plugged in, through the use of solar panels, such as those that may be present on the device but not shown in FIG. 1, or by any known recharging method.

Additionally, Hall effect sensors may be placed on the unit, such as on one side of the unit and on the back or front of the unit, in order that the first pass path may include indication of a relative origin, so as to give the robotic lawnmower an orientation, heading, and start position.

Embodiments of the present invention may also account for wheel slippage, which, in addition to techniques above, may be assessed by monitoring current draw, such as to each wheel. If one current draw is much lower, that wheel is most likely slipping because there is not as much load on the motor.

Embodiments of the present invention may also include a notification system to let the user know when the robot has run into an issue, such as an obstacle that it detects. The notification may/may not include an image or video to show the user what is wrong. May then have the option to override the function and have the mower continue to mow, or tell it to turn off, from local or remote position.

Embodiments of the present invention may also include the use of control using a smartphone or remote control, such as using an app, through Wifi or radio frequency. This may include a live video feed.

Embodiments of the present invention may also include remote monitoring of the robot telementary (current speed, battery charge, sensor readings and ETA, and the like) and may be live footage of mowing operation, may also be included in an app.

Embodiments of the present invention may include a tilt sensor to determine if the robot has tipped over or if it is being stolen. In any case, the tilt sensor may send an alert and/or stop the blades from spinning.

Embodiments of the present invention may also employ the use of an alternative energy source which may power the robot eg. bio-fuels (such as grass clippings), solar, or wind.

Embodiments of the present invention may include a home base for the robot to charge and to give the robot a point of reference for each repetition of path. The home base may use a radio frequency or ping-type sensor, or a combination of the two (or multiples of each) to help the robot direct itself back to the start position and re-align itself for the next pass. The home base may also act as a charging station through direct terminal contact or through induction charging.

As will be appreciated in light of the discussion herein, the present invention may have numerous applications, both residential and commercial. Further, by modifying the presence of the cutting blades with the presence of other operating elements, the present invention may be used to provide a vacuum cleaner, a snow blower, a leaf pickup, a fertilizer or pesticide spreader, farming equipment, a salt spreader, or the like. Moreover, the disclosed embodiment may be modified to include “plug and play” modules, such as wherein a lawn mowing module may be removed, and one or more of the aforementioned alternatives modules may be inserted, such that the same frame and sensors may be employed in multiple different operations.

Although the invention has been described and illustrated in exemplary forms with a certain degree of particularity, it is noted that the description and illustrations have been made by way of example only. Numerous changes in the details of construction, combination, and arrangement of parts and steps may be made. Accordingly, such changes are intended to be included within the scope of the disclosure, the protected scope of which is defined by the claims.

What is claimed is:

1. A robotic control system, comprising:
a frame;
at least three wheels mounted to said frame, wherein at least one of the at least three wheels comprise drive wheels;
at least one drive motor for driving, and which is physically associated with, the at least one drive wheel;
a plurality of sensors associated with the at least one drive wheel;
at least one memory module for non-transitory storage of a plurality of first pass data; and
at least one microprocessor communicatively associated with the memory module and communicatively associated with at last said plurality of sensors, wherein the plurality of first pass data is read by said at least one microprocessor from said plurality of sensors on a first physical pass across a lawn under direction from a user and is stored by said at least one microprocessor in said memory module, and wherein the plurality of first pass data is read from said memory module by said at least one microprocessor and input by said at least one microprocessor to direct said plurality of sensors to produce autonomous action by at least the at least one drive wheel on a later physical pass across the lawn subsequent to the first pass.

2. A robotic control system, comprising:
a frame;
at least three wheels mounted to said frame, wherein at least one of the at least three wheels comprise drive wheels;
at least one drive motor for driving, and which is physically associated with, the at least one drive wheel;
a plurality of sensors associated with the at least one drive wheel;
at least one memory module for non-transitory storage of a plurality of first pass data;
at least one position sensor for recording an actual position of the robotic system; and
at least one microprocessor communicatively associated with the memory module and communicatively associated with at last said plurality of sensors, wherein the plurality of first pass data is read by said at least one microprocessor from said plurality of sensors on a first physical pass across a lawn under direction from a user and is stored by said at least one microprocessor in said memory module, and wherein the plurality of first pass data is read from said memory module by said at least one microprocessor and input by said at least one microprocessor to direct said plurality of sensors to produce autonomous action by at least the at least one drive wheel on a later physical pass across the lawn subsequent to the first pass.
